(19) United States
(12) Patent Application Publication
(10) Pub. No.: US 2008/0082505 A1
(43) Pub. Date: Apr. 3, 2008

(54) DOCUMENT SEARCHING APPARATUS AND COMPUTER PROGRAM PRODUCT THEREFOR

(75) Inventors: Tomoharu Kokubu, Kanagawa (JP); Toshihiko Manabe, Kanagawa (JP); Tetsuya Sakai, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/851,260

(22) Filed: Sep. 6, 2007

(30) Foreign Application Priority Data
Sep. 28, 2006 (JP) 2006-264202

(51) Int. Cl. G06F 17/30

(52) U.S. Cl. 707/3; 707/E17.014

(57) ABSTRACT

A document searching apparatus includes an input unit that inputs a search query for conducting a search in a structured document, the structured document being obtained by expressing elements included in a document in a hierarchical manner; a query converting unit that converts a query sentence constituting the search query and a search target element of the query sentence according to a predetermined rule so as to generate a new search query; a document searching unit that searches the structured document by using the new search query; and a search-result presenting unit that presents a result of the search.

### CROSS-REFERENCE TO RELATED APPLICATIONS

This application is based upon and claims the benefit of priority from the prior Japanese Patent Application No. 2006-264202, filed on Sep. 28, 2006; the entire contents of which are incorporated herein by reference.

### BACKGROUND OF THE INVENTION

1. Field of the Invention

The present invention relates to a document searching apparatus and a computer program product therefor.

2. Description of the Related Art

Conventionally, documents have been managed by the texts in many cases. Recently, however, it has become common to manage documents by structuring them into a structured document that has a hierarchical logical structure, and an example of such a structured document is one written in Extensible Markup Language (XML).

For structured documents like ones written in XML, a query language is provided. The query language has a syntax similar to that of SQL (Structured Query Language) used for relational databases. With the query language, it is possible to write an element being a search target and a character string that is included in a search target. For example, in XPATH that is formulated by the World Wide Web Consortium (W3C ), when a search is to be conducted in XML documents for a document that contains a character string “SHIZEN GENGO SHORI (=natural language processing)” within an element “YOUYAKU (=summary)” so that the “title” is output as a result, it will be expressed as follows:

/document[YOUYAKU//, contains (“SHIZEN GENGO SHORI”)]/title

In this example, “contains (X)” means that a character string X is contained in the element that has been specified as a search target.

In addition, besides the search method that simply checks to see if a specified character string is contained in a document, the W3C has been considering the use of other query languages with which it is possible to apply techniques that have conventionally been studied in the field of document searches, the techniques namely being, for example, for performing a morphological analysis on “SHIZEN GENGO KENSAKU (=natural language search)” and returning a result based on a search ranking according to a vector space method (Term Frequency-Inverse Document Frequency [hereinafter, “TF-IDF”]).

However, when a detailed search is to be conducted for a structured document by specifying a specific element as described above, a problem arises where the user is required to know the details such as the name of the elements in the structured document being the search target.

To solve this problem, JP-A 2003-296355 (KOKAI) discloses a technique for applying a thesaurus expansion to both an element name and a query sentence that have been input so that it is possible to conduct a search even if a different element name is used. As another example, JP-A 2002-297605 (KOKAI) discloses a technique that makes it possible to conduct a search in a similar structured document based on similarity of a query sentence and similarity of the structure of an element being the search target.

However, according to the techniques disclosed in JP-A 2003-296355 (KOKAI) and JP-A 2002-297605 (KOKAI), the search is conducted only in a structured document that is similar to a structured document found in a search by using a search query based on transcriptions of vocabulary and structural similarities. Thus, these techniques are not sufficient to make it possible to conduct a search in documents desired by a user in a flexible manner.

For example, in the example above where a search query is used to conduct a search for a document that contains a character string “SHIZEN GENGO SHORI (=natural language processing)” within an element “YOUYAKU (=summary)”, it is not possible to, by using the same search query, search for a document that contains a character string “natural language processing (in English)” within an element “summary (in English)”.

### SUMMARY OF THE INVENTION

According to one aspect of the present invention, a document searching apparatus includes an input unit that inputs a search query for conducting a search in a structured document, the structured document being obtained by expressing elements included in a document in a hierarchical manner; a query converting unit that converts a query sentence constituting the search query and a search target element of the query sentence according to a predetermined rule so as to generate a new search query; a document searching unit that searches the structured document by using the new search query; and a search-result presenting unit that presents a result of the search.

According to another aspect of the present invention, a computer program product having a computer readable medium including programmed instructions for conducting a search in a structured document in which elements included in a document are expressed in a hierarchical manner, wherein the instructions, when executed by a computer, cause the computer to perform: inputting a search query for conducting a search in a structured document, the structured document being obtained by expressing elements included in a document in a hierarchical manner; converting a query sentence constituting the search query and a search target element of the query sentence according to a predetermined rule so as to generate a new search query; conducting a searches the structured document by using the new search query; and presenting a result of the search.

### BRIEF DESCRIPTION OF THE DRAWINGS

FIG. 1 is a hardware configuration diagram according to a first embodiment of the present invention;

FIG. 2 is a schematic block diagram of a functional configuration;

FIG. 3 is a schematic drawing illustrating examples of conversion rules;

FIG. 4 is a schematic drawing illustrating examples of structured document indexes;

FIG. 5 is a schematic drawing illustrating an example of a vocabulary index;

FIG. 6 is a schematic drawing illustrating examples of documents that are used as a search target;

FIG. 7 is a schematic flowchart of a procedure in a process performed by a converting unit;

FIG. 8 is a schematic drawing illustrating an example of a structured document;

FIG. 9 is a schematic flowchart of a procedure in a process performed by a searching unit;

FIG. 10 is a schematic drawing illustrating an example of an output result;

FIG. 11 is a schematic drawing illustrating examples of conversion rules according to a second embodiment of the present invention;

FIG. 12 is a schematic flowchart of a procedure in a process performed by the searching unit;

FIG. 13 is a schematic drawing illustrating examples of documents that are used as a search target;

FIG. 14 is a schematic drawing illustrating an example of an output result;

FIG. 15 is a schematic drawing illustrating modification examples of output results;

FIG. 16 is a schematic drawing illustrating examples of conversion rules according to a third embodiment of the present invention;

FIG. 17 is a schematic drawing illustrating examples of documents that are used as a search target; and

FIG. 18 is a schematic drawing illustrating an example of an output result.

### DETAILED DESCRIPTION OF THE INVENTION

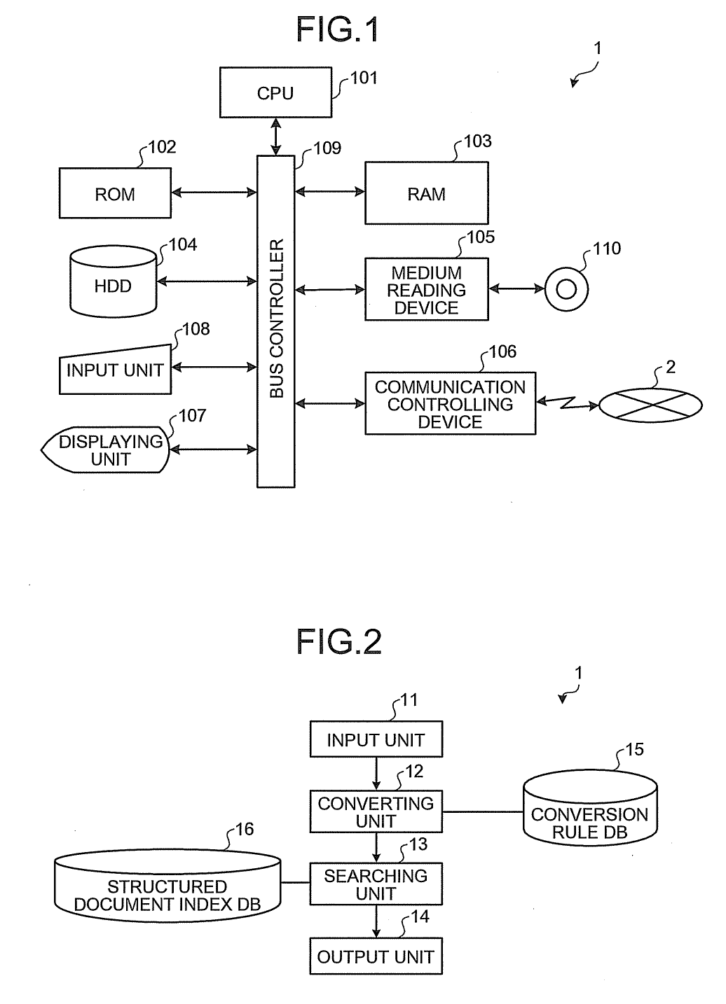

A first embodiment of the present invention will be explained with reference to FIGS. 1 to 10. In the present example, structured documents each of which has a hierarchical logical structure may be a document that is written in Extensible Markup Language (XML) or in Standard Generalized Markup Language (SGML). SGML is a standard formulated by the International Organization for Standardization (ISO). XML is a standard formulated by the World Wide Web Consortium (W3C ). These are each an agreement for structured documents that makes it possible to structurize documents. In the explanation below, a document written in XML is used as an example of a structured document.

FIG. 1 is a hardware configuration diagram of a document searching apparatus 1 according to the first embodiment. For example, the document searching apparatus 1 is a commonly-used personal computer.

As shown in FIG. 1, the document searching apparatus 1 includes a Central Processing Unit (CPU) 101 that performs information processing; a Read Only Memory (ROM) 102 that stores therein a Basic Input/Output System (BIOS) and the like; a Random Access Memory (RAM) 103 that stores therein various types of data in a rewritable manner; a Hard Disk Drive (HDD) 104 that functions as various types of databases and also stores therein various types of programs; a medium driving device 105 like a Compact Disk Read Only Memory (CD-ROM) drive that is used for storing information, distributing information to the outside of the document searching apparatus 1, and obtaining information from the outside of the document searching apparatus 1, with the use of a storage medium 110; a communication controlling device 106 used for transmitting information to other computers on the outside of the document searching apparatus 1 through communication via a network 2; a displaying unit 107 such as a Cathode Ray Tube (CRT) or a Liquid Crystal Display (LCD) that displays the progress or a result of a process to an operator; and an input unit 108 such as a keyboard or a mouse that is used by an operator to input an instruction or information to the CPU 101. The document searching apparatus 1 operates while a bus controller 109 arbitrates the data transmitted and received among these elements.

In the document searching apparatus 1, when a user turns on the electric power thereof, the CPU 101 runs a program that is called a loader and is stored in the ROM 102. A program that is called an Operating System (OS) and manages hardware and software in the computer is read from the HDD 104 into the RAM 103 so that the OS is activated. The OS runs a program according to an operation by the user, reads information, and stores information. A typical example of an OS is Windows (registered trademark). Operation programs that run on such an OS are called application programs. Application programs include not only programs that operate on a predetermined OS, but also programs that cause an OS to take over execution of a part of various types of processes described later, as well as programs that are contained in a group of program files that constitute predetermined application software or an OS.

The document searching apparatus 1 has a structured-document searching program stored in the HDD 104, as an application program. In this sense, the HDD 104 functions as a storage medium that has stored therein the structured-document searching program.

Generally, each of the application programs to be installed in the HDD 104 included in the document searching apparatus 1 is recorded in one of storage media 110 including optical disks such as CD-ROMs and Digital Versatile Disks (DVDs), various types of magneto optical disks, various types of magnetic disks such as flexible disks, and media that use various methods such as semiconductor memories, so that the operation programs recorded on the storage media 110 can be installed into the HDD 104. Thus, storage media 110 that are portable, like optical information recording media such as CD-ROMs and magnetic media such as Floppy Disks (FDs), can also be each used as a storage medium for storing therein an application program. Further, it is also acceptable to install application programs into the HDD 104 after obtaining the application programs from an external source via, for example, the communication controlling device 106.

In the document searching apparatus 1, when the structured-document searching program that operates on the OS is run, the CPU 101 performs various types of computation processes and controls the functional units in an integrated manner, according to the structured-document searching program. Of the various types of computation processes performed by the CPU 101 included in the document searching apparatus 1, characteristic processes according to the first embodiment will be explained below.

FIG. 2 is a schematic block diagram of a functional configuration of the document searching apparatus 1. As shown in FIG. 2, the document searching apparatus 1 includes, by following the structured-document searching program, an input unit 11, a converting unit 12, a searching unit 13, and an output unit 14. Also, the document searching apparatus 1 forms, by following the structured-document searching program, a conversion rule database (hereinafter, “conversion rule DB”) 15 and a structured-document index database (hereinafter, “structured document index DB”) 16 within the HDD 104.

The input unit 11 has a function of receiving an input of a search query from a user. The converting unit 12 has a function of converting the search query received by the input unit 11 into a search query that is suitable for conducting a search in structured documents being a search target. The searching unit 13 has a function of conducting a search in the structured documents by using the search query converted by the converting unit 12. The output unit 14 has a function of presenting a search result obtained by the searching unit 13 to the user.

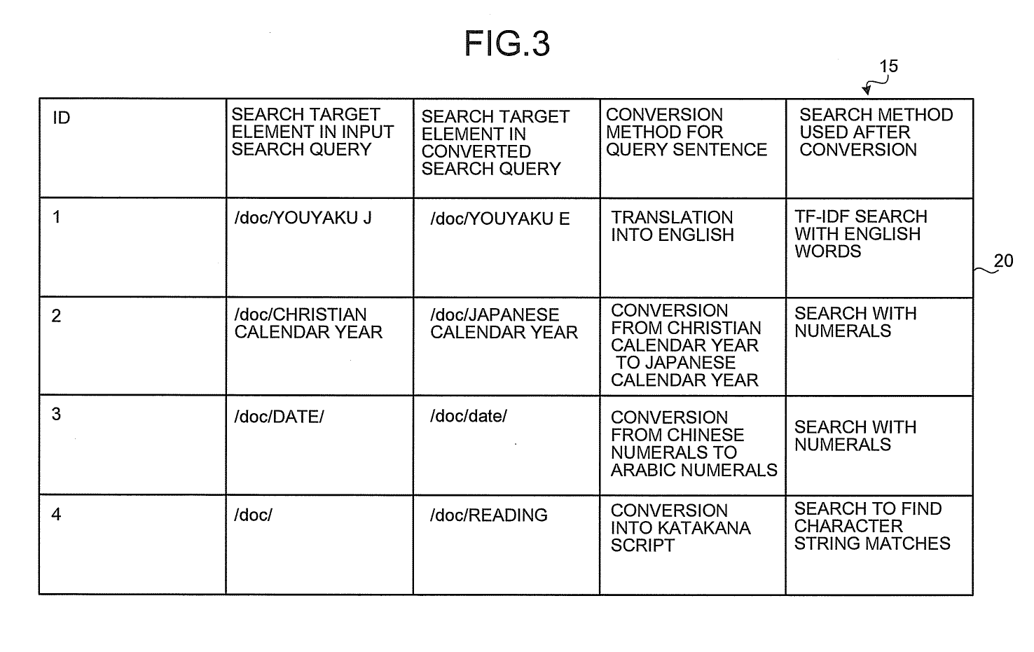

The conversion rule DB 15 is a database that stores therein conversion rules 20. FIG. 3 is a schematic drawing illustrating examples of the conversion rules 20 stored in the conversion rule DB 15. As shown in FIG. 3, each of the conversion rules 20 includes: an “ID” that shows the number assigned to the rule; a “search target element in input search query” that shows a search target element in the input search query; a “search target element in converted search query” that shows a search target element in the converted search query; a “conversion method for query sentence” that is used for converting the query sentence in the input search query; and a “search method used after conversion” that shows what search method is used to conduct a search on structured documents being a search target by using a query sentence, according to the converted search target element. For example, one of the conversion rules 20 of which the “ID” is “1” shows that when the search target element in an input search query is “/YOUYAKU J (=summary J)”, the search target element is converted into a search target element “/YOUYAKU E (=summary E)”, “Translation into English” is applied to the input query sentence, and a “TF-IDF search on English words” is performed by using the converted search target element and the query sentence. “Translation into English” in this situation denotes translating the query sentence into English. It is acceptable to use machine translation performed by an existing English translation system.

The “search method used after conversion” is a portion that specifies a search method that corresponds to the converted search target element and the converted query sentence. This item is specified because it is necessary to specify an optimal search method for the converted query sentence for the reason that, for example, a suitable method for processing words can be different between when a search is conducted in a document written in Japanese and when a search is conducted in a document written in English. As another example, when a Kanji/Kana sentence (i.e., a sentence written by using both Chinese characters and Japanese phonetic characters) obtained as a result of performing automatic audio recognition on information uttered by a speaker is expressed in an element specified by “/audio recognition”, and also the reading of the “/audio recognition” that uses the Japanese phonetic characters is expressed in an element specified by “/audio recognition reading”, an input query sentence is converted into a query sentence written in the Japanese phonetic characters with respect to the “/audio recognition reading” portion, and a search method that uses “edit distance” is used.

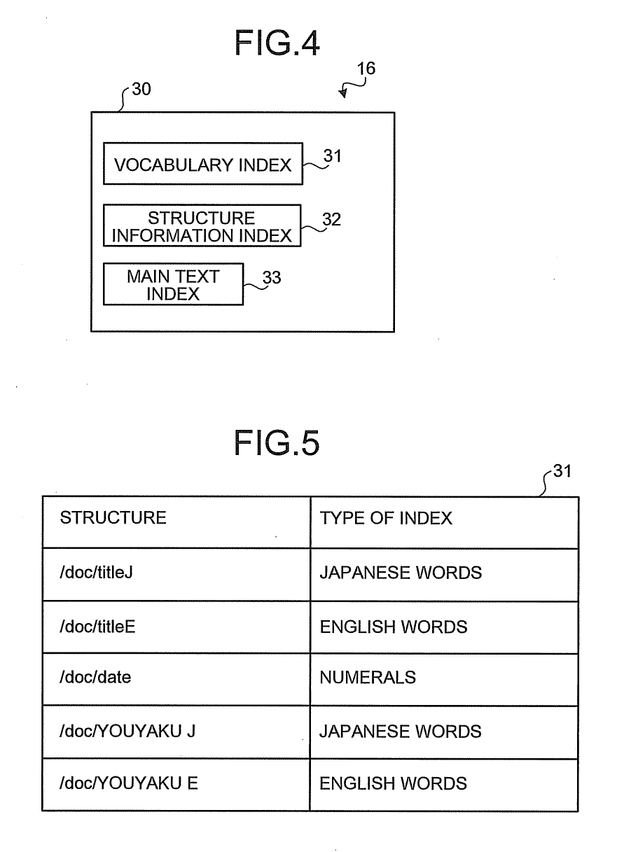

The structured document index DB 16 is a database that stores therein structured document indexes 30. FIG. 4 is a schematic drawing illustrating examples of the structured document indexes 30 stored in the structured document index DB 16. As shown in FIG. 4, the structured document indexes 30 include: a vocabulary index 31 that stores therein vocabulary information of the elements included in a structured document in which the elements included in the document are expressed in a hierarchical manner; a structure information index 32 that stores therein structure information related to parents, children, and siblings of the elements included in the structured document; and a main text index 33 that stores therein main text information of the structured document.

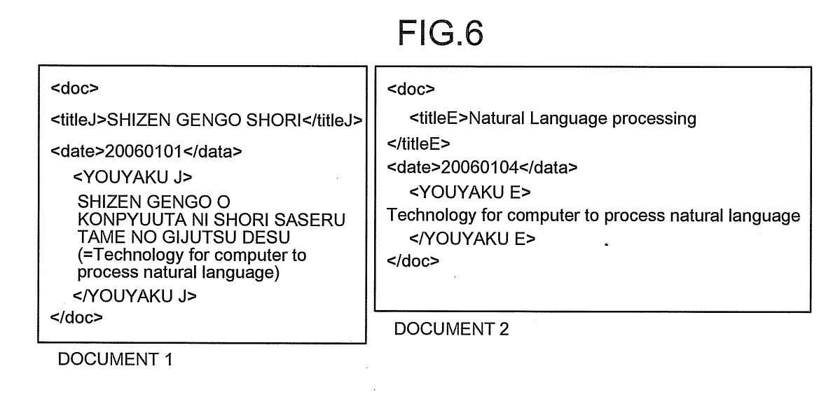

For example, in the vocabulary index 31 shown in FIG. 5, structured documents are associated with indexes according to the type of index of each of the elements appearing in the structured documents 1 and 2 shown in FIG. 6. The character string appearing in the element “/title J” included in the structured document 1 shown in FIG. 6 is associated with an index “Japanese words” as shown in FIG. 5. In this situation, the index “Japanese words” is used to have the index associated with information indicating that a morphological analysis is performed on the character string “SHIZEN GENGO SHORI (=natural language processing)” included in “/title J” so that words such as “SHIZEN (=natural)”, “GENGO (=language)”, and “SHORI (=processing)” are extracted, and these words appear in “/doc/title J” in the structured document 1. Also, the character string appearing in the element “/title E” included in the structured document 2 shown in FIG. 6 is associated with an index “English words” as shown in FIG. 5. In this situation, the index “English words” is used for having the index associated with information indicating that a stemming process is performed on each of the words included in “/title E” so that words such as “natural”, “language”, and “process” are extracted, and these words appear in “/title E” in the structured document 2. The stemming process is a process to eliminate inflection of words. Further, like in these examples, a corresponding piece of information is associated with an index for each of other elements such as “/date”, “/YOUYAKU J (=summary J)” and “/YOUYAKU E (=summary E)” that are included in the structured documents 1 and 2.

Next, a schematic procedure in the process performed with the configuration above will be explained. First, the input unit 11 receives a search query that has been input by a user and forwards the received search query to the converting unit 12. The converting unit 12 serves as a query converting unit. Having received the search query from the input unit 11, the converting unit 12 converts the search query by using the conversion rules 20 stored in the conversion rule DB 15 and forwards the converted search query to the searching unit 13. The searching unit 13 serves as a document searching unit. The searching unit 13 conducts a search on constituting elements of structured documents, based on the structured document indexes 30 stored in the structured document index DB 16 by using the search query received from the converting unit 12 and forwards a search result to the output unit 14. The output unit 14 serves as a search-result presenting unit. The output unit 14 presents the received search result to the user.

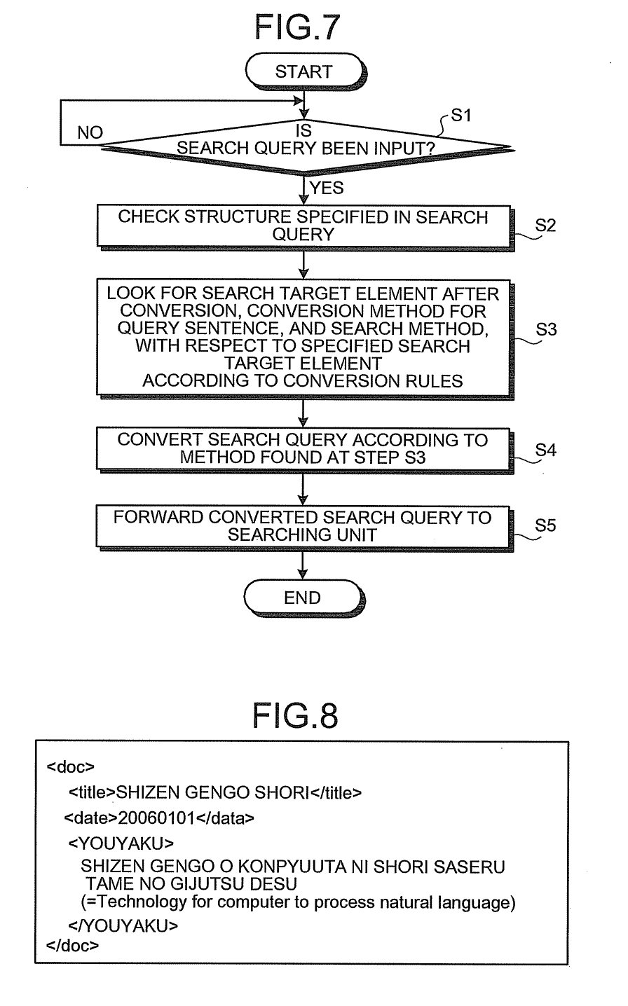

Next, the converting unit 12 will be explained further in detail. FIG. 7 is a schematic flowchart of the procedure in the process performed by the converting unit 12. As shown in FIG. 7, the converting unit 12 receives the search query from the input unit 11 (step S1: Yes).

In this situation, a process of “conducting a search for a document that contains SHIZEN GENGO (=natural language) in the YOUYAKU (=summary) and returning the title thereof as a result” that is performed on structured documents like the one shown in FIG. 8 can be expressed in XPATH as “/doc[/YOUYAKU/, contains(SHIZEN GENGO)]/title”. According to the first embodiment, we focus on the portions written in XPATH such as a portion that indicates an element being a search target such as “/YOUYAKU”; a portion that indicates the search method such as “contains(X)”; a portion that indicates the query sentence such as “SHIZEN GENGO”; and a portion that indicates an element to be presented as a search result such as “/title”. These portions will be referred to as a search target element specifying portion, a query sentence portion, a search method specifying portion, and a presented element specifying portion, respectively. In other words, in XPATH, the search target element specifying portion is expressed as “/YOUYAKU (=summary)”; the query sentence portion is expressed as “SHIZEN GENGO (=natural language)”; the search method specifying portion is expressed as “contains”; and the presented element specifying portion is expressed as “/title”.

In the present example, in the search query received from the input unit 11, the search target element specifying portion is “/YOUYAKU J (=summary J)”; the query sentence portion is “SHIZEN GENGO SHORI (=natural language processing)”; and the search method specifying portion is “TF-IDF search with Japanese words”.

Next, the converting unit 12 checks the search target element specified in the search query received from the input unit 11 (step S2). As a result, it is understood that the element “YOUYAKU J (=summary J)” has been specified.

Subsequently, the converting unit 12 looks for a search target element after a conversion, the conversion method for the query sentence, and the search method, with respect to the specified search target element, according to the conversion rules 20 of which some examples are shown in FIG. 3 (step S3). For example, according to one of the conversion rules 20 of which the “ID” is “1”, when the search target element in the input search query is “/YOUYAKU J (=summary J)”, the search target element is converted into a search target element “/YOUYAKU E (=summary E)”, so that “English translation” is applied to the input query sentence, and a “TF-IDF search with English words” is performed by using the converted search target element and the converted query sentence.

After that, the converting unit 12 converts the search query according to the method found at step S3 (step S4). In the present example, the query sentence “SHIZEN GENGO SHORI (=natural language processing)” within the search query received from the input unit 11 is translated into “natural language processing” according to the conversion rule 20.

As a result of the process described above, the input search query in which ‘the search target element specifying portion is “/YOUYAKU J (=summary J)”; the query sentence portion is “SHIZEN GENGO SHORI (=natural language processing)”; and the search method specifying portion is “TF-IDF search with Japanese words”’ is converted into a search query in which ‘the search target element specifying portion is “/YOUYAKU E (=summary E)”; the query sentence portion is “natural language processing”; and the search method specifying portion is “TF-IDF search with English words”’.

Finally, the converting unit 12 forwards the converted search query to the searching unit 13 (step S5).

The conversion method for the query sentence is not limited to the example shown in FIG. 3. For example, when some of the elements indicate a specific field, it is acceptable to apply a synonym expansion by using a corresponding synonym dictionary.

Next, the searching unit 13 will be explained further in detail. By using the search query received from the converting unit 12 and the structured document indexes 30, the searching unit 13 conducts a search in structured documents and forwards a result to the output unit 14.

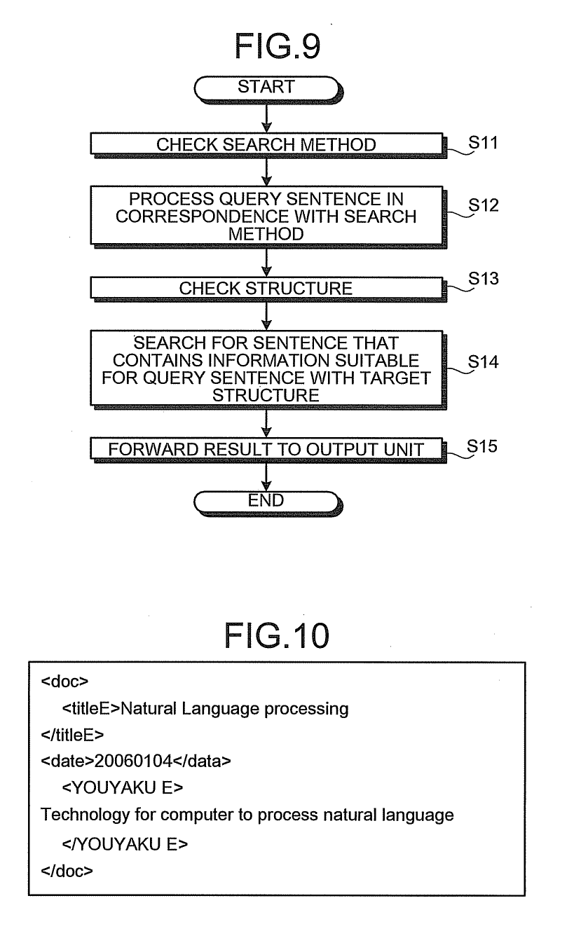

FIG. 9 is a schematic flowchart of the procedure in the process performed by the searching unit 13. As shown in FIG. 9, first, the searching unit 13 checks the search method or form for the search query received from the converting unit 12 (step S11). In the present example, the search method for the search query received from the converting unit 12 is a “TF-IDF search with English words”.

Next, the searching unit 13 processes the query sentence in correspondence with the search method (step S12). In the present example, a stemming process is performed on the query sentence “natural language processing” so that “natural”, “language”, and “process” are extracted as search words.

Next, the searching unit 13 checks a structure (i.e., an element) that is used as the search target (step S13). In the present example, it is understood that the structure (i.e., the element) being the search target is “/YOUYAKU E (=summary E)”.

Subsequently, the searching unit 13 searches for a document that contains information suitable for the query sentence within the target structure (i.e., the target element) (step S14). In the present example, it is understood that, based on the vocabulary index 31 included in the structured document indexes 30, “natural”, “language”, and “process” appear in the “/YOUYAKU E (=summary E)” in the structured document 2, and that the structured document 2 is a suitable search result.

Finally, the searching unit 13 obtains the structured document 2 from the main text index and forwards it to the output unit 14 as the search result (step S15).

The output unit 14 presents an output result as shown in FIG. 10, for example, to the user.

As explained above, according to the first embodiment, a new search query is generated by converting, according to the predetermined rule, a query sentence that constitutes a search query and an element being a search target of the query sentence. Thus, by setting the predetermined rule so that, when the search target element in a search query is “/YOUYAKU J (=summary J)”, the search target element is converted into a search target element “/YOUYAKU E (=summary E)”, before “English translation” is applied to the input query sentence, and a “TF-IDF search with English words” is performed by using the converted search target element and the converted query sentence, it is possible to conduct a search for a document that contains a character string “natural language processing” within the element “summary”, based on the search query indicating that a search should be conducted for a document that contains “SHIZEN GENGO SHORI (=natural language processing)” within an element “YOUYAKU (=summary)”. Consequently, it is possible to search for a document desired by a user in a flexible manner.

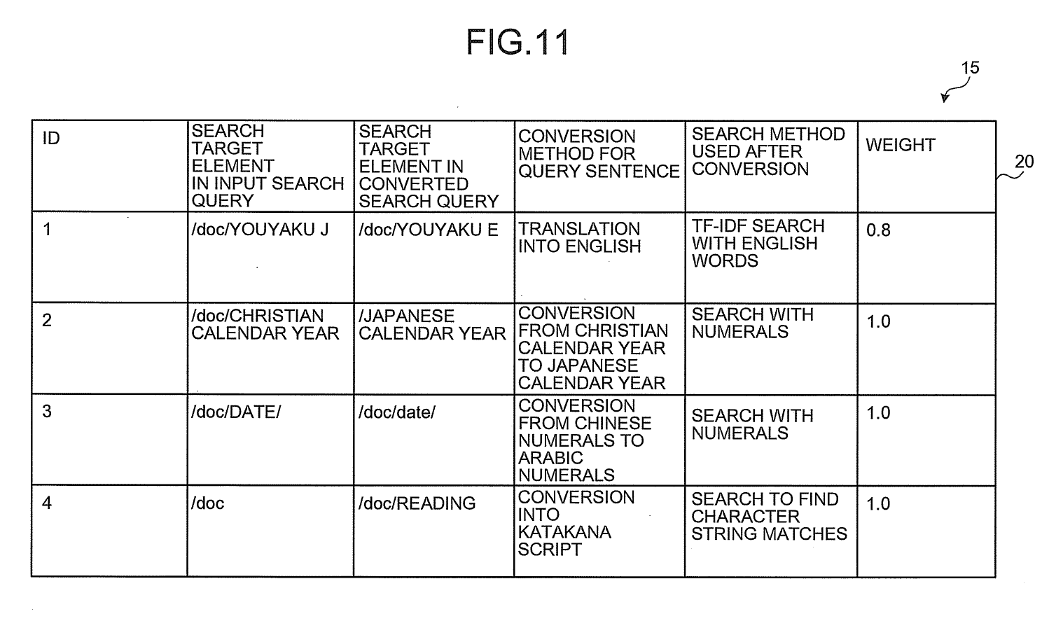

Next, a second embodiment will be explained with reference to FIGS. 11 to 15. The functional units that are the same as those in the first embodiment will be referred to by using the same reference characters, and the explanation thereof will be omitted.

The difference between the second embodiment and the first embodiment is that the searching unit 13 has a function of conducting a search in structured documents by using both a query input by a user and a search query converted by the converting unit 12 and rearranging the structured documents found in the search in an appropriate order.

A schematic procedure of the process according to the second embodiment will be explained below. First, the input unit 11 receives a search query input by a user and forwards the received search query to the converting unit 12. Having received the search query from the input unit 11, the converting unit 12 converts the search query by using the conversion rules 20 stored in the conversion rule DB 15 and forwards the converted search query and the input search query to the searching unit 13. The searching unit 13 conducts a search on constituent elements of structured documents, based on the structured document indexes 30 stored in the structured document index DB 16 by using both the converted search query and the input search query received from the converting unit 12 and forwards a search result to the output unit 14. The output unit 14 presents the received search result to the user.

Next, the converting unit 12 will be explained further in detail. The converting unit 12 according to the second embodiment is different from the converting unit 12 according to the first embodiment in that the conversion rules 20 include weights for adjusting scores that are used when a search is conducted in structured documents by using a search query converted according to the conversion rules 20.

For example, the converting unit 12 according to the second embodiment receives, from the input unit 11, a search query in which the search target element specifying portion is “/YOUYAKU J (=summary J)”; the query sentence portion is “SHIZEN GENGO SHORI (=natural language processing)”; and the search method specifying portion is “TF-IDF search with Japanese words”. The converting unit 12 then converts the received search query into a search query in which the search target element specifying portion is “/YOUYAKU E (=summary E)”; the query sentence portion is “natural language processing”; and the search method specifying portion is “ITF-IDF search with English words”, by using the conversion rules 20 shown in FIG. 11. Also, as shown in FIG. 11, the conversion rules 20 according to the second embodiment include “weights” for adjusting the scores that are used when a search is conducted in the structured documents. The converting unit 12 forwards the converted search query that includes a weight “0.8” and the input search query to the searching unit 13.

Next, the searching unit 13 will be explained further in detail. By using the converted search query including the weight and the input search query that have been received from the converting unit 12 as well as the structured document indexes 30, the searching unit 13 conducts a search in structured documents and forwards a result to the output unit 14.

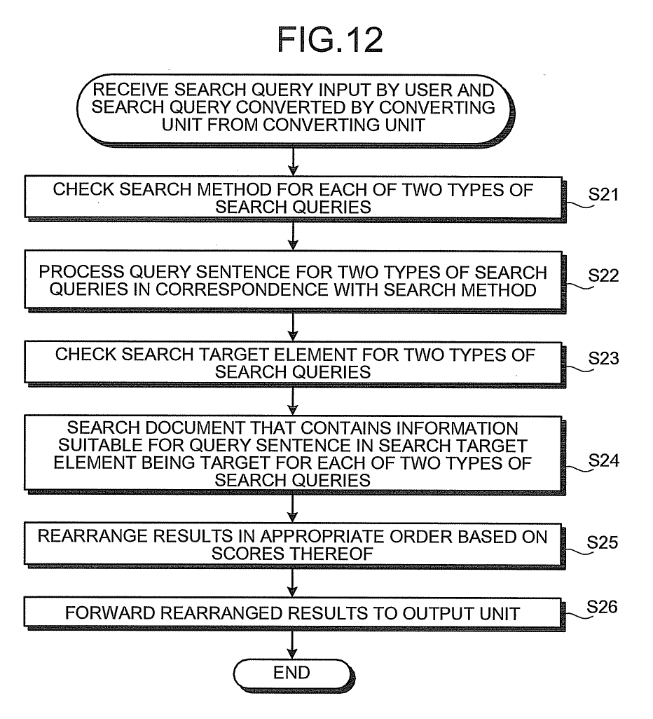

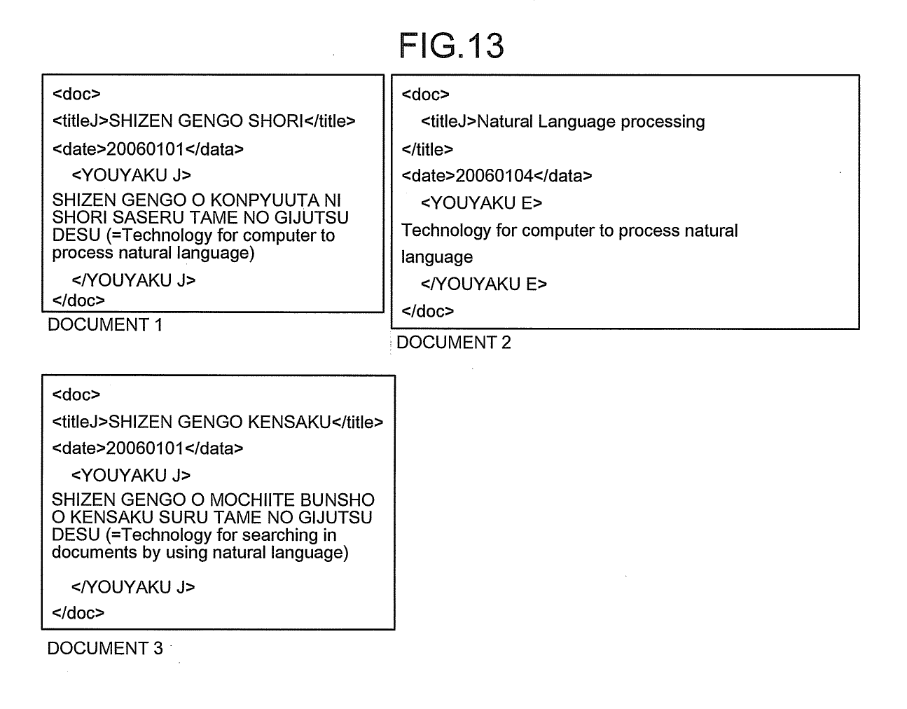

FIG. 12 is a schematic flowchart of the procedure in the process performed by the searching unit 13. FIG. 13 is a schematic drawing illustrating examples of documents that are used as a search target. As shown in FIG. 12, the searching unit 13 checks the search method for each of the two types of search queries received from the converting unit 12 (step S21). In the present example, it is assumed that the searching unit 13 has received two types of search queries as the following: a search query input by a user in which ‘the search target element specifying portion is “/YOUYAKU J (=summary J)”; the query sentence portion is “SHIZEN GENGO SHORI (=natural language processing)”; and the search method specifying portion is “TF-IDF search with Japanese words”’ and a converted search query in which ‘the search target element specifying portion is “/YOUYAKU E (=summary E)”; the query sentence portion is “natural language processing”; and the search method specifying portion is “TF-IDF search with English words”’. In this situation, the searching unit 13 also receives the weight “0.8” for the converted search query. As a result, the search method for the converted search query received from the converting unit 12 is a “TF-IDF search with English words”, and the search method for the search query that has been input by the user and has been received from the converting unit 12 is a “TF-IDF search with Japanese words”.

Next, the searching unit 13 processes the query sentences in the two types of search queries received from the converting unit 12, in correspondence with the search methods (step S22). In the present example, a stemming process is performed on the converted query sentence “natural language processing” so that “natural”, “language”, and “process are extracted as search words. Also, a morphological analysis is performed on the search query “SHIZEN GENGO SHORI (=natural language processing)” that has been input by the user so that “SHIZEN (=natural)”, “GENGO (=language)”, and “SHORI (=processing)” are extracted as search words.

Subsequently, the searching unit 13 checks the structures (i.e., the elements) that are used as the search targets for the two types of search queries (step S23). In the present example, it is understood that the structures (i.e., the elements) being the search targets are “/YOUYAKU E (=summary E)” and “/YOUYAKU J (=summary J)”.

After that, the searching unit 13 conducts a search for a document that contains information suitable for the query sentence within the target structure (i.e., the target element) for each of the two types of search queries (step S24). When the search is conducted in the structured documents 1, 2, and 3 shown in FIG. 13 by using the two types of search queries, the structured document 1 in which “SHIZEN (=natural)”, “GENGO (=language)”, and “SHORI (=processing)” appear in “YOUYAKU J (=summary J)” and the structured document 3 in which “SHIZEN (=natural)” and “GENGO (=language)” appear in “YOUYAKU J (=summary J)” are found in the search, based on the search query that has been input by the user. Also, the structured document 2 in which “natural”, “language”, and “process” appear in “YOUYAKU E (=summary E)” is found in the search, based on the search query converted by the converting unit 12.

In the next step, the searching unit 13 rearranges the search results in an appropriate order based on the scores thereof (step S25). According to the second embodiment, each of the documents is scored by using the TF-IDF method. As a TF, the frequency indicating how often a word in question appears in the search target element is used. As an IDF, to keep it simple, 1/DF (Document Frequency: the number of documents in which a word in question appears) is used. In this situation, for example, it is assumed that “SHIZEN” is considered as the same word as its translated equivalent “natural”; “GENGO” is considered as the same word as its translated equivalent “language”; and “SHORI” is considered as the same words as its translated equivalent “processing”. Based on this assumption, the score of the document 1 is expressed as below:

(TF-IDF of the word “SHIZEN”)+(TF-IDF of the word “GENGO”)+(TF-IDF of the word “SHORI”)=1*1/3+1*1/3+1*1/3=1

The score of the document 2 is expressed as below:

(TF-IDF of the word “natural”)+(TF-IDF of the word “language”)+(TF-IDF of the word “process”)=1*1/3+1*1/3+1*1/3=1

The score of the document 3 is expressed as below:

(TF-IDF of the word “SHIZEN”)+(TF-IDF of the word “GENGO”)=1*1/3+1*1/3=0.67

In addition, the searching unit 13 applies the weight “0.8” for adjusting the score to the document 2 that is the search result from the converted search query. As a result of this process, the score of the document 2 is further expressed as below:

1*0.8=0.8

As a result of the processes described above, the scores of the documents found in the search can be expressed as below:

the score of the document 1>the score of the document 2>the score of the document 3

Finally, the searching unit 13 obtains main text information of the search results from the main text index and forwards the obtained information to the output unit 14, together with the ranking order of the scores (step S26).

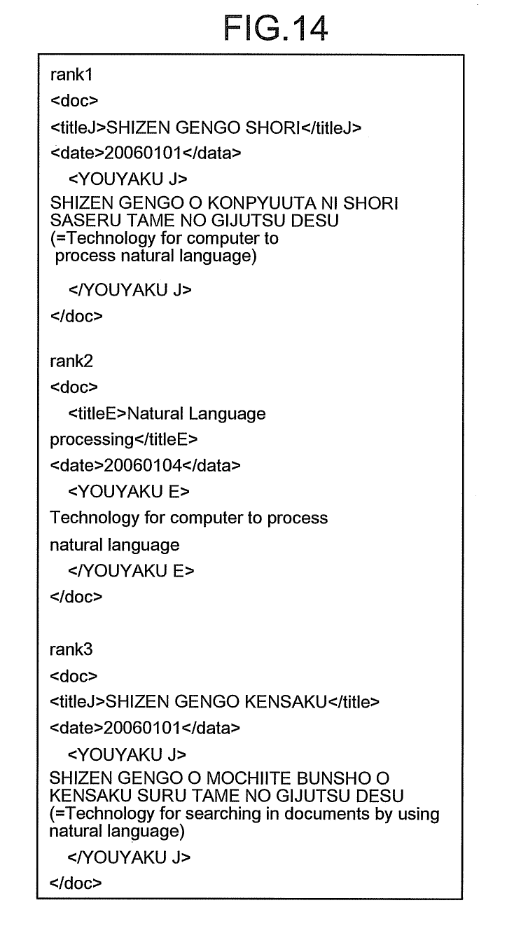

The output unit 14 presents the search results together with the ranking order, as shown in FIG. 14, for example.

As explained above, according to the second embodiment, the searching unit 13 conducts a search in structured documents by using both a search query input by a user and a search query converted by the converting unit 12 and rearranges the structured documents found in the search in an appropriate order. Thus, it is possible to obtain a search result desired by the user.

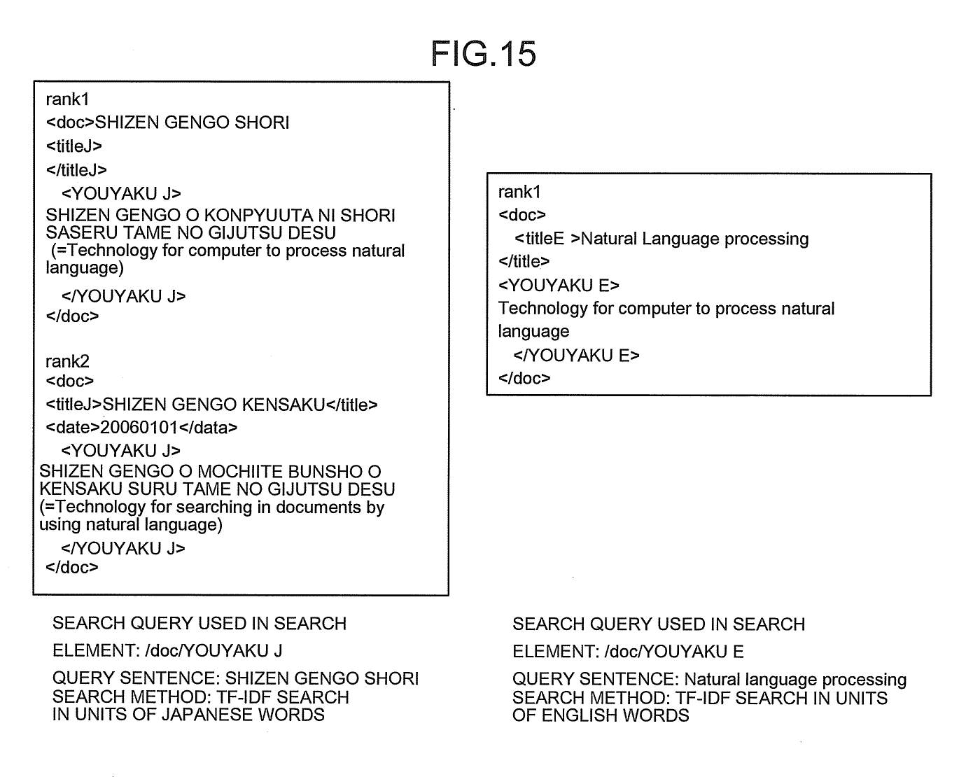

In the example shown in FIG. 14, the search query input by the user and the search query converted by the converting unit 12 are eventually output in a collective manner after being arranged in an ascending order. However, it is also acceptable to output the results by separating them for each of the search queries. In that situation, as shown in FIG. 15, for example, it is acceptable to present each of the documents being the search results with a corresponding one of the search queries forwarded to the searching unit 13 so that the user is able to intuitively understand why each of the results has been obtained.

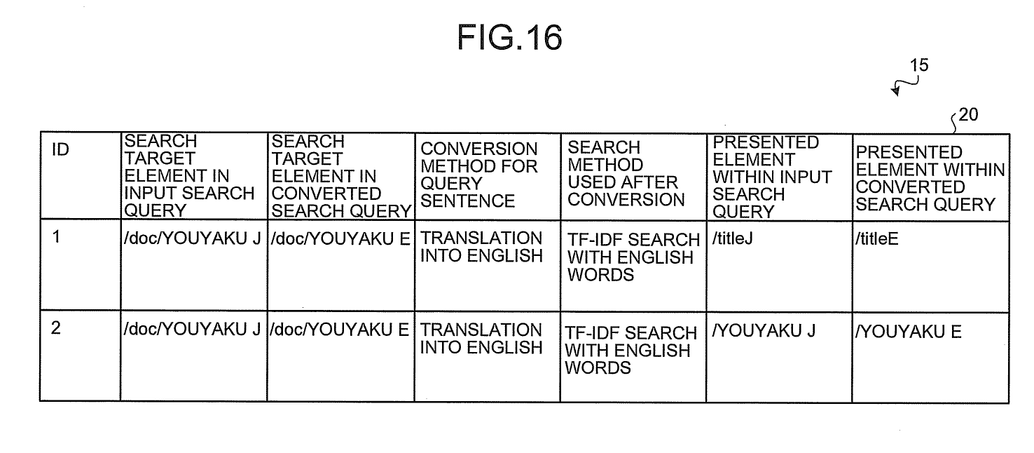

Next, a third embodiment will be explained with reference to FIGS. 16 to 18. The functional units that are the same as those in the first embodiment will be referred to by using the same reference characters, and the explanation thereof will be omitted.

The difference between the third embodiment and the first embodiment is that the converting unit 12 has a function of also converting a presented element specifying portion specified in a search query input by a user.

The difference in a relevant module between the first embodiment and the third embodiment will be explained below.

For example, it is assumed that the input unit 11 receives a search query in which the search target element specifying portion is “/YOUYAKU J (=summary J)”; the query sentence portion is “SHIZEN GENGO SHORI (=natural language processing)”; the search method specifying portion is “TF-IDF search with Japanese words”; and the presented element specifying portion is “/title J”, as a search query that has been input by a user and indicates that “a search should be conducted for a document that contains SHIZEN GENGO SHORI in YOUYAKU J and the title J should be returned as a result”. The input unit 11 forwards the search query to the converting unit 12.

Having received from the input unit 11 the search query in which the search target element specifying portion is “/YOUYAKU J (=summary J)”; the query sentence portion is “SHIZEN GENGO SHORI (=natural language processing)”; the search method specifying portion is “TF-IDF search with Japanese words”; and the presented element specifying portion is “/title J”, the converting unit 12 according to the third embodiment converts the search query by using the conversion rules 20 shown in FIG. 16.

As shown in FIG. 16, the conversion rules 20 according to the third embodiment includes, in addition to the configuration shown in FIG. 3, a “presented element within input search query” that indicates an element to be presented that is specified within an input search query and a “presented element within converted search query” that indicates an element to be presented within a converted search query.

Among the conversion rules 20, the converting unit 12 looks for a rule that has the same “search target element within input search query” as the search target element specifying portion in the input search query and also has the same “presented element within input search query” as the presented element specifying portion in the input search query. As a result, the converting unit 12 finds the rule of which the ID is “1”.

Next, the converting unit 12 converts the input search query according to the rule of which the ID is “1”. As a result of this process, the search query in which the search target element specifying portion is “/YOUYAKU J (=summary J)”; the query sentence portion is “SHIZEN GENGO SHORI (=natural language processing)”; the search method specifying portion is “TF-IDF search with Japanese words”; and the presented element specifying portion is “/title J” is converted into a search query in which the search target element specifying portion is “YOUYAKU E (=summary E)“; the query sentence portion is ” natural language processing”; the search method specifying portion is “TF-IDF search with English words”; and the presented element specifying portion is “/title E”. The result of the conversion is forwarded from the converting unit 12 to the searching unit 13.

The searching unit 13 conducts a search in structured documents by using the search query received from the converting unit 12 and the structured document indexes 30 and forwards a result to the output unit 14.

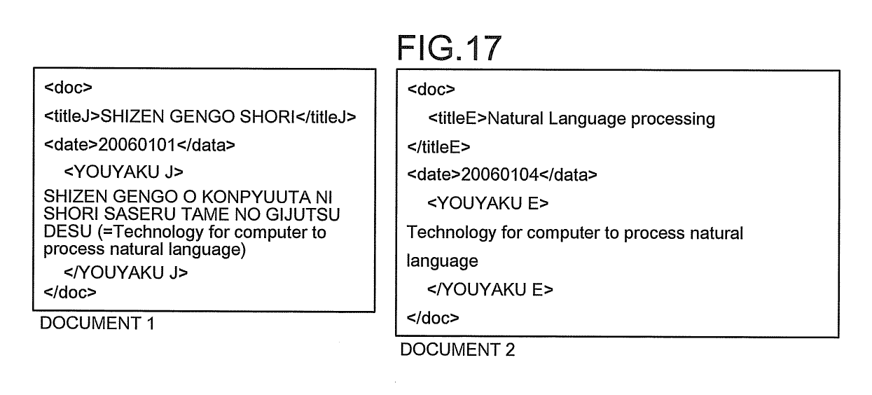

The searching unit 13 receives, from the converting unit 12, the search query in which the search target element specifying portion is “/YOUYAKU E (=summary E)”; the query sentence portion is “natural language processing”; the search method specifying portion is “TF-IDF search with English words”; and the presented element specifying portion is “/title E”. When the searching unit 13 conducts a search in documents, for example, as shown in FIG. 17, by using the search query, the structured document 2 is found in the search.

Finally, the searching unit 13 obtains information subordinate to “/title E” specified in the presented element specifying portion within the search result from the main text index 33 and forwards the obtained information to the output unit 14 as a search result.

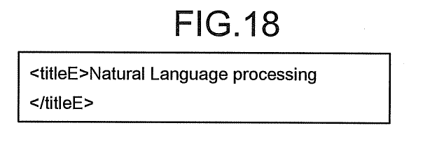

The output unit 14 presents an output result, for example, as shown in FIG. 18 to the user.

As explained above, according to the third embodiment, because the converting unit 12 also converts the presented element specifying portion specified in the search query input by the user, it is possible to output, for the user, an element that is appropriate as a search result.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document searching apparatus comprising:
an input unit that inputs a search query for conducting a search in a structured document, the structured document being obtained by expressing elements included in a document in a hierarchical manner;
a query converting unit that converts a query sentence constituting the search query and a search target element of the query sentence according to a predetermined rule so as to generate a new search query;
a document searching unit that searches the structured document by using the new search query; and
a search-result presenting unit that presents a result of the search.

2. The apparatus according to claim 1, wherein the query converting unit also converts a search form used for the search constituting the search query according to a predetermined rule.

3. The apparatus according to claim 1, wherein
the document searching unit not only conducts the searches the structured document by using the converted and new search query, but also conducts a search by using the search query before being converted, and
the search-result presenting unit presents the result of the search corresponding to the search query before being converted and the search query after being converted.

4. The apparatus according to claim 1, wherein
the document searching unit not only conducts the searches the structured document by using the converted and new search query, but also conducts a search by using the search query before being converted, and determines a ranking of the result of the search corresponding to the search query before being converted and the search query after being converted, and
the search-result presenting unit presents the result of the search corresponding to the search query before being converted and the search query after being converted, after rearranging the the result of the search in an order that corresponds to the determined ranking.

5. The apparatus according to claim 1, wherein
the structured document includes a vocabulary index that associates with an index according to types of indexes of the elements included in the structured document, and
the document searching unit conducts the search in the structured document by using the vocabulary index.

6. The apparatus according to claim 1, wherein the query converting unit also converts a presented element according to a predetermined rule, when the presented element to be presented as a search result by the search-result presenting unit is specified within the search query before being converted.

7. The apparatus according to claim 1, wherein the query converting unit translates the query sentence by using a machine translation.

8. The apparatus according to claim 1, wherein the search-result presenting unit presents the result of the search conducted by the document searching unit in correspondence with the search query.a

9. A computer program product having a computer readable medium including programmed instructions for conducting a search in a structured document in which elements included in a document are expressed in a hierarchical manner, wherein the instructions, when executed by a computer, cause the computer to perform:
inputting a search query for conducting a search in a structured document, the structured document being obtained by expressing elements included in a document in a hierarchical manner;
converting a query sentence constituting the search query and a search target element of the query sentence according to a predetermined rule so as to generate a new search query;
conducting a searches the structured document by using the new search query; and
presenting a result of the search.
